(19) United States
(12) Patent Application Publication
(10) Pub. No.: US 2026/0133218 A1
(43) Pub. Date: May 14, 2026

(54) INFORMATION PROCESSING DEVICE AND ERROR ESTIMATION METHOD FOR ACCELERATION SENSOR

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventor: Chao CHEN, Tokyo (JP)

(21) Appl. No.: 19/383,191

(22) Filed: Nov. 7, 2025

(30) Foreign Application Priority Data
Nov. 11, 2024 (JP) 2024-196695

(51) Int. Cl. G01P 15/08

(52) U.S. Cl. CPC G01P 15/08

(57) ABSTRACT

An information processing device acquires an output value of an acceleration sensor mounted to a vehicle and an output value of a vehicle speed sensor mounted to the vehicle. This device estimates an error amount of the output value of the acceleration sensor, based on the output value of the acceleration sensor in a time period in which a time integral of a translational acceleration of the vehicle in a lateral axis direction is zero and on a change in a vehicle speed of the vehicle in the time period derived from the output value of the vehicle speed sensor.

### CROSS-REFERENCE TO RELATED APPLICATION

This application is based on and claims the benefit of priority from earlier Japanese Patent Application No. 2024-196695, filed in Japan on Nov. 11, 2024, the description of which is hereby incorporated by reference.

### BACKGROUND

### 1. Technical Field

The present disclosure relates to an information processing device and an error estimation method for an acceleration sensor.

### 2. Related Art

Regarding techniques for estimating an error of an acceleration sensor mounted to a vehicle, a technique is known which uses an output value of the acceleration sensor acquired when the vehicle is stopped on a flat road surface to estimate an error of the acceleration sensor.

### SUMMARY

An aspect of the present disclosure provides an information processing device. The information processing device acquires an output value of an acceleration sensor mounted to a vehicle and an output value of a vehicle speed sensor mounted to the vehicle. The information processing device estimates an error amount of the output value of the acceleration sensor, based on the output value of the acceleration sensor in a time period in which a time integral of a translational acceleration of the vehicle in a lateral axis direction is zero and on a change in a vehicle speed of the vehicle in the time period derived from the output value of the vehicle speed sensor.

### BRIEF DESCRIPTION OF THE DRAWINGS

In the accompanying drawings:

FIG. 1 is a hardware configuration diagram of an information processing device of a first embodiment;

FIG. 2 is a block diagram of the information processing device of the first embodiment;

FIG. 3 is a first explanatory diagram illustrating a mounting angle error of an acceleration sensor;

FIG. 4 is a second explanatory diagram illustrating a mounting angle error of the acceleration sensor;

FIG. 5 is an explanatory diagram illustrating a mode of an attitude angle of a vehicle;

FIG. 6 is a flowchart illustrating a procedure of an error estimation process of the first embodiment;

FIG. 7 is an explanatory diagram illustrating an estimation result of a trajectory of the vehicle; and

FIG. 8 is a flowchart illustrating a procedure of an error estimation process of a second embodiment.

### DETAILED DESCRIPTION OF THE PREFERRED EMBODIMENTS

According to the conventional technique, for example, described in JP 3168820 B2 (Japanese Patent No. 3168820), the error of the acceleration sensor cannot be estimated with high accuracy without acquiring an output value of the acceleration sensor during a vehicle stop. Hence, a technique is desired which estimates an error of an acceleration sensor with high accuracy by using an output value of the acceleration sensor acquired during the vehicle travel.

The present disclosure can be implemented in the following aspect.

According to an aspect of the present disclosure, an information processing device is provided. The information processing device includes an acquisition unit and an estimation unit. The acquisition unit acquires an output value of an acceleration sensor mounted to a vehicle and an output value of a vehicle speed sensor mounted to the vehicle. The estimation unit estimates an error amount of the output value of the acceleration sensor, based on the output value of the acceleration sensor in a time period in which a time integral of a translational acceleration of the vehicle in a lateral axis direction is zero and on a change in a vehicle speed of the vehicle in the time period derived from the output value of the vehicle speed sensor.

According to the information processing device of the aspect above, an error of the acceleration sensor can be estimated with high accuracy by using an output value of the acceleration sensor acquired during the vehicle travel.

An information processing device according to each embodiment will be described in detail below, referring to the drawings.

### A. First Embodiment

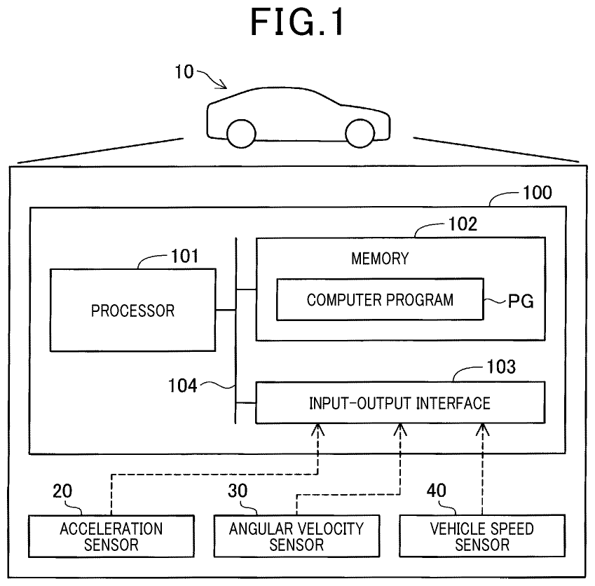

As illustrated in FIG. 1, an information processing device 100 of the present embodiment is installed in a vehicle 10. In addition to the information processing device 100, an acceleration sensor 20, an angular velocity sensor 30, and a vehicle speed sensor 40 are mounted to the vehicle 10. The acceleration sensor 20 detects accelerations of the vehicle 10 in three-axis (X-axis, Y-axis, and Z-axis) directions. The angular velocity sensor 30 detects angular velocities of the vehicle 10 around the three axes. The vehicle speed sensor 40 detects a vehicle speed of the vehicle 10. For the acceleration sensor 20 and the angular velocity sensor 30, for example, an inertial measurement unit (IMU) may be used. The IMU is capable of detecting accelerations along three axes and angular velocities around the three axes. For the vehicle speed sensor 40, for example, a wheel speed sensor may be used. The wheel speed sensor is capable of detecting a vehicle speed based on a rotational speed of a wheel.

The information processing device 100 is configured by a computer including a processor 101, a memory 102, an input-output interface 103, and an internal bus 104. The processor 101, the memory 102, and the input-output interface (I/O interface) 103 are interconnected via the internal bus 104 to enable bidirectional communication. The input-output interface 103 is connected with the acceleration sensor 20, the angular velocity sensor 30, and the vehicle speed sensor 40, for example, via signal cables.

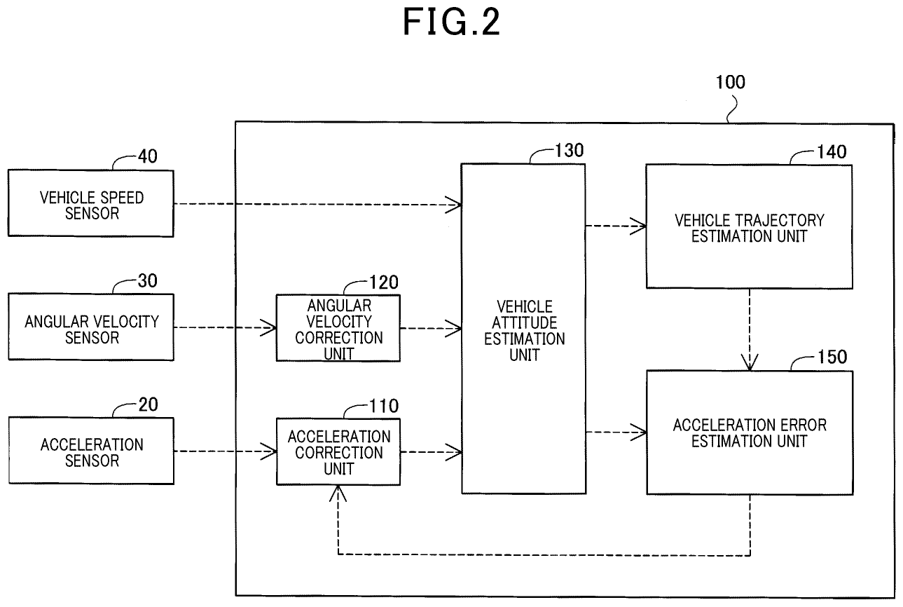

As illustrated in FIG. 2, the processor 101 executes a computer program PG previously stored in the memory 102 to function as an acceleration correction unit 110, an angular velocity correction unit 120, a vehicle attitude estimation unit 130, a vehicle trajectory estimation unit 140, and an acceleration error estimation unit 150. The acceleration correction unit 110 corrects output values of accelerations in the X, Y, and Z-axis directions acquired from the acceleration sensor 20. The angular velocity correction unit 120 corrects output values of angular velocities around the X, Y, and Z-axes acquired from the angular velocity sensor 30. The vehicle attitude estimation unit 130 estimates an attitude of the vehicle 10 based on output values acquired from the various sensors 20, 30, and 40. Specifically, the vehicle attitude estimation unit 130 estimates directions of the X, Y, and Z-axes of the vehicle in the three-dimensional space. The vehicle trajectory estimation unit 140 estimates a trajectory of the vehicle 10 in the three-dimensional space based on output values acquired from the various sensors 20, 30, and 40, and the attitudes of the vehicle 10 estimated by the vehicle attitude estimation unit 130. The vehicle trajectory estimation unit 140 estimates a trajectory of the vehicle 10 by using, for example, a Kalman filter. The acceleration error estimation unit 150 estimates an error amount of the acceleration sensor 20. The acceleration correction unit 110 corrects an output value of the acceleration sensor 20 depending on the error amount estimated by the acceleration error estimation unit 150. It is noted that the information processing device 100 may be configured by a computer including one or more processors. For example, the multiple processors can perform the above-described various functions by executing the computer program PG previously stored in the memory 102. Furthermore, at least one of the acceleration correction unit 110, the angular velocity correction unit 120, the vehicle attitude estimation unit 130, the vehicle trajectory estimation unit 140, and the acceleration error estimation unit 150, for example, may be implemented by a circuit. The circuit may include one or more hardware logic circuits configured to execute specific processing.

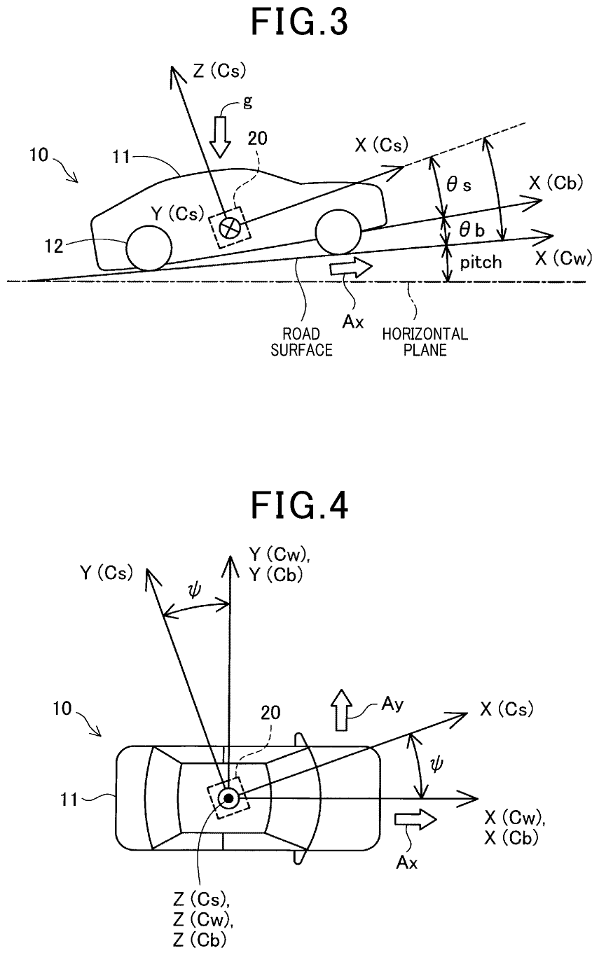

In FIG. 3 and FIG. 4, the coordinate axis of a wheel coordinate system Cw, the coordinate axis of a vehicle body coordinate system Cb, and the coordinate axis of a sensor coordinate system Cs are shown. The wheel coordinate system Cw is a coordinate system of four wheels 12 of the vehicle 10. The vehicle body coordinate system Cb is a coordinate system of a vehicle body 11 of the vehicle 10. The sensor coordinate system Cs is a coordinate system of the acceleration sensor 20. Each of the coordinate systems Cs, Cb, and Cw is an orthogonal coordinate system with X, Y, and Z coordinate axes as reference axes. The X-axis of the wheel coordinate system Cw is a longitudinal axis of the vehicle 10, the Y-axis of the wheel coordinate system Cw is a lateral axis of the vehicle 10, and the Z-axis of the wheel coordinate system Cw is a vertical axis of the vehicle 10.

The acceleration sensor 20 is mounted on the vehicle body 11. When the mounting angle of the acceleration sensor 20 to the vehicle body 11 has no misalignment (i.e., the acceleration sensor 20 is accurately mounted to the vehicle body 11), and the vehicle body 11 is not inclined with respect to the road surface, the direction of the coordinate axis of the wheel coordinate system Cw, that of the vehicle body coordinate system Cb, and that of the sensor coordinate system Cs agree with each other. However, a misalignment may be caused in the mounting angle of the acceleration sensor 20 to the vehicle body 11. When the mounting angle of the acceleration sensor 20 relative to the vehicle body 11 is misaligned, a misalignment is caused in the mounting angle of the acceleration sensor 20 to the vehicle body 11, and a misalignment is caused between the direction of the coordinate axis of the sensor coordinate system Cs and that of the vehicle body coordinate system Cb. Furthermore, due to the weight of passengers and loads of the vehicle 10, the vehicle body 11 may be inclined with respect to the road surface. When the vehicle body 11 is inclined with respect to the road surface, a misalignment is caused between the direction of the coordinate axis of the vehicle body coordinate system Cb and that of the wheel coordinate system Cw. The direction of the coordinate axis of the sensor coordinate system Cs and that of the vehicle body coordinate system Cb do not change while the vehicle 10 is traveling. The direction of the coordinate axis of the vehicle body coordinate system Cb and that of the wheel coordinate system Cw change due to expansion and contraction of the suspension, or the like, while the vehicle 10 is traveling.

In the example illustrated in FIG. 3, when viewed in parallel to the road surface, a misalignment of an angle θs is caused between the X-axis of the sensor coordinate system Cs and that of the vehicle body coordinate system Cb, and, furthermore, a misalignment of an angle θb is caused between the X-axis of the vehicle body coordinate system Cb and that of the wheel coordinate system Cw. Hence, a misalignment of an angle θ=θs+θb is caused between the X-axis of the sensor coordinate system Cs and that of the wheel coordinate system Cw. In the example illustrated in FIG. 4, when viewed from the vertical direction of the road surface, misalignments of angles ψ are caused between the X and Y-axes of the wheel coordinate system Cw and that of the sensor coordinate system Cs. When the direction of the coordinate axis of the sensor coordinate system Cs and that of the wheel coordinate system Cw are misaligned from each other, an error occurs between output values of X, Y, and Z of the acceleration sensor 20 and accelerations of X, Y, and Z of the vehicle 10. In the following description, the misalignment between the direction of the coordinate axis of the sensor coordinate system Cs and that of the wheel coordinate system Cw is referred to as a mounting angle error.

In addition, when the zero point of the acceleration sensor 20 is misaligned, although no acceleration acts on the acceleration sensor 20 in practice, an output value of the acceleration sensor 20 becomes other than zero. Hence, an error occurs between output values of X, Y, and Z of the acceleration sensor 20 and accelerations of X, Y, and Z of the vehicle 10. In the following description, an error due to the misalignment of the zero point of the acceleration sensor 20 is referred to as an offset error. The offset error may be referred to as a bias error or a zero-point error.

While the vehicle 10 is stopped, a gravitational acceleration g caused by the gravity acts on the acceleration sensor 20. While the vehicle 10 is traveling, translational accelerations Ax and Ay caused by travel of the vehicle 10 and the gravitational acceleration g caused by the gravity act on the acceleration sensor 20.

Typically, since the vehicle 10 moves parallel to the road surface during travel, translational accelerations Ax and Ay act parallel to the road surface.

Acceleration sensor output values gx, gy, and gz acquired when the vehicle 10 is stopped can be expressed by the following expression (1). gx is an acceleration sensor output value in the X-axis direction, gy is an acceleration sensor output value in the Y-axis direction, and gz is an acceleration sensor output value in the Z-axis direction. gx, gy, and gz are values in the sensor coordinate system Cs.

$$[ Math . 1 ]$$

$$[ \begin{matrix}1 & ψ & - θ \\ - ψ & 1 & ϕ \\ θ & - ϕ & 1\end{matrix} ] \{ {R}_{x} {R}_{y} {R}_{z} [ \text{} \begin{matrix}0 \\ 0 \\ g\end{matrix} ] \} + [ \text{} \begin{matrix}{b}_{x} \\ {b}_{y} \\ {b}_{z}\end{matrix} ] = \qquad ( 1 )$$

$$[ \text{} \begin{matrix}1 & ψ & - θ \\ - ψ & 1 & ϕ \\ θ & - ϕ & 1\end{matrix} ] [ \text{} \begin{matrix}g \cdot sin ( pitch ) \\ g \cdot sin ( roll ) cos ( pitch ) \\ g \cdot cos ( roll ) cos ( pitch )\end{matrix} ] + [ \text{} \begin{matrix}{b}_{x} \\ {b}_{y} \\ {b}_{z}\end{matrix} ] = [ \text{} \begin{matrix}{g}_{x} \\ {g}_{y} \\ {g}_{z}\end{matrix} ]$$

Herein, g is the gravitational acceleration. φ, θ, and ψ are mounting angle errors of the acceleration sensor 20. φ is a mounting angle error around the X-axis. θ is a mounting angle error around the Y-axis. ψ is a mounting angle error around the Z-axis. bx, by, and bz are offset errors of the acceleration sensor 20. bx is an offset error in the X-axis direction. by is an offset error in the Y-axis direction. bz is an offset error in the Z-axis direction. Rx, Ry, and Rz are rotation matrices around the X, Y, and Z-axes. Rx is a rotation matrix around the X-axis. Ry is a rotation matrix around the Y-axis. Rz is a rotation matrix around the Z-axis. pitch and roll are attitude angles of the vehicle 10 with respect to the horizontal plane. pitch is a pitch angle, and roll is a roll angle.

Herein, if the mounting angle error is expressed as an offset error, the acceleration sensor output values gx, gy, and gz can be expressed by the following expression (2).

$$[ Math . 2 ]$$

$$[ \begin{matrix}1 & 0 & 0 \\ 0 & 1 & 0 \\ 0 & 0 & 1\end{matrix} ] [ \begin{matrix}g \cdot sin ( pitch ) \\ g \cdot sin ( roll ) cos ( pitch ) \\ g \cdot cos ( roll ) cos ( pitch )\end{matrix} ] + [ \begin{matrix}- g θ cos ( roll ) cos ( pitch ) + {b}_{x} \\ g ϕ cos ( roll ) cos ( pitch ) + {b}_{y} \\ {b}_{z}\end{matrix} ] = \qquad ( 2 )$$

$$[ \begin{matrix}g \cdot sin ( pitch ) - g θ cos ( roll ) cos ( pitch ) + {b}_{x} \\ g \cdot sin ( roll ) cos ( pitch ) + g ϕ cos ( roll ) cos ( pitch ) + {b}_{y} \\ g \cdot cos ( roll ) cos ( pitch ) + {b}_{z}\end{matrix} ] = [ \text{} \begin{matrix}{g}_{x} \\ {g}_{y} \\ {g}_{z}\end{matrix} ]$$

Herein, if the offset error is expressed as a mounting angle error, the acceleration sensor output values gx, gy, and gz can be expressed by the following expression (3). In cases where the influence of the mounting angle error, such as when it exceeds 5 degrees, is greater than that of the offset error, it is permissible to regard the offset error as the mounting angle error.

$$[ Math . 3 ]$$

$$[ \begin{matrix}1 & ψ & - θ + \frac{{b}_{x}}{g cos ( roll ) cos ( pitch )} \\ - ψ & 1 & ϕ + \frac{{b}_{y}}{g cos ( roll ) cos ( pitch )} \\ θ & - ϕ & 1 + \frac{{b}_{z}}{g cos ( roll ) cos ( pitch )}\end{matrix} ] [ \begin{matrix}g \cdot sin ( pitch ) \\ g \cdot sin ( roll ) cos ( pitch ) \\ g \cdot cos ( roll ) cos ( pitch )\end{matrix} ] = [ \begin{matrix}{g}_{x} \\ {g}_{y} \\ {g}_{z}\end{matrix} ] \qquad ( 3 )$$

The acceleration sensor output values ax, ay, and az acquired when the vehicle 10 is traveling can be expressed by the following expression (4). ax is an acceleration sensor output value in the X-axis direction. ay is an acceleration sensor output value in the Y-axis direction. az is an acceleration sensor output value in the Z-axis direction. ax, ay, and az are values in the sensor coordinate system Cs.

$$[ Math . 4 ]$$

$$[ \begin{matrix}1 & ψ & - θ \\ - ψ & 1 & ϕ \\ θ & - ϕ & 1\end{matrix} ] \{ [ \begin{matrix}g \cdot sin ( pitch ) \\ g \cdot sin ( roll ) cos ( pitch ) \\ g \cdot cos ( roll ) cos ( pitch )\end{matrix} ] + [ \text{} \begin{matrix}Ax \\ Ay \\ 0\end{matrix} ] \} + [ \text{} \begin{matrix}{b}_{x} \\ {b}_{y} \\ {b}_{z}\end{matrix} ] = \qquad ( 4 )$$

$$[ \begin{matrix}{g}_{x} \\ {g}_{y} \\ {g}_{z}\end{matrix} ] + [ \begin{matrix}Ax + Ay ψ \\ - Ax ψ + Ay \\ Ax θ - Ay ϕ\end{matrix} ] = [ \begin{matrix}{a}_{x} \\ {a}_{y} \\ {a}_{z}\end{matrix} ] =$$

$$[ \begin{matrix}g \cdot sin ( pitch ) - g θ cos ( roll ) cos ( pitch ) + {b}_{x} + A x + Ay ψ \\ g \cdot sin ( roll ) cos ( pitch ) + g ϕ cos ( roll ) cos ( pitch ) + {b}_{y} - Ax ψ + Ay \\ g \cdot cos ( roll ) cos ( pitch ) + {b}_{z} + Ax θ - Ay ϕ\end{matrix} ]$$

Herein, Ax and Ay are translational accelerations caused by travel of the vehicle 10. Ax is a translational acceleration in the X-axis direction. Ay is a translational acceleration in the Y-axis direction. Ax and Ay are values in the wheel coordinate system Cw.

To help understand, a case where the vehicle 10 is stopped on a horizontal road surface and another where it travels only on a horizontal road surface will be described. In the case where the vehicle 10 is stopped on a horizontal road surface, the acceleration sensor output values gx, gy, and gz can be expressed by the following expression (5).

$$[ Math . 5 ]$$

$$[ \begin{matrix}1 & ψ & - θ \\ - ψ & 1 & ϕ \\ θ & - ϕ & 1\end{matrix} ] [ \begin{matrix}0 \\ 0 \\ g\end{matrix} ] + [ \begin{matrix}{b}_{x} \\ {b}_{y} \\ {b}_{z}\end{matrix} ] = [ \begin{matrix}{g}_{x} \\ {g}_{y} \\ {g}_{z}\end{matrix} ] \qquad ( 5 )$$

In the case where the vehicle 10 is stopped on the horizontal road surface, if the mounting angle error is expressed as an offset error, the acceleration sensor output values gx, gy, and gz can be expressed by the following expression (6).

$$[ Math . 6 ]$$

$$[ \begin{matrix}1 & 0 & 0 \\ 0 & 1 & 0 \\ 0 & 0 & 1\end{matrix} ] [ \begin{matrix}0 \\ 0 \\ g\end{matrix} ] + [ \begin{matrix}- g θ + {b}_{x} \\ g ϕ + {b}_{y} \\ {b}_{z}\end{matrix} ] = [ \begin{matrix}{g}_{x} \\ {g}_{y} \\ {g}_{z}\end{matrix} ] \qquad ( 6 )$$

In the case where the vehicle 10 is stopped on the horizontal road surface, if the offset error is expressed as a mounting angle error, the acceleration sensor output values gx, gy, and gz can be expressed by the following expression (7).

$$[ Math . 7 ]$$

$$[ \begin{matrix}1 & ψ & - θ + \frac{{b}_{x}}{g} \\ - ψ & 1 & ϕ + \frac{{b}_{y}}{g} \\ θ & - ϕ & 1 + \frac{{b}_{z}}{g}\end{matrix} ] [ \begin{matrix}0 \\ 0 \\ g\end{matrix} ] = [ \begin{matrix}{g}_{z} \\ {g}_{y} \\ {g}_{z}\end{matrix} ] \qquad ( 7 )$$

In the case where the vehicle 10 travels only on the horizontal road surface, the acceleration sensor output values ax, ay, and az can be expressed by the following expression (8).

$$[ Math . 8 ]$$

$$[ \begin{matrix}1 & ψ & - θ \\ - ψ & 1 & ϕ \\ θ & - ϕ & 1\end{matrix} ] \{ [ \begin{matrix}0 \\ 0 \\ g\end{matrix} ] + [ \text{} \begin{matrix}Ax \\ Ay \\ 0\end{matrix} ] \} + [ \text{} \begin{matrix}{b}_{x} \\ {b}_{y} \\ {b}_{z}\end{matrix} ] = [ \text{} \begin{matrix}{g}_{x} \\ {g}_{y} \\ {g}_{z}\end{matrix} ] + \qquad ( 8 )$$

$$[ \begin{matrix}Ax + Ay ψ \\ - Ax ψ + Ay \\ Ax θ - Ay ϕ\end{matrix} ] = [ \begin{matrix}{a}_{x} \\ {a}_{y} \\ {a}_{z}\end{matrix} ] = [ \begin{matrix}- g θ + {b}_{x} + Ax + Ay ψ \\ g ϕ + {b}_{y} - Ax ψ + Ay \\ {b}_{z} + Ax θ - Ay ϕ\end{matrix} ]$$

### <Estimation Method of Error Amount of Acceleration Sensor Output Value>

A method of estimating an error amount of an output value of the acceleration sensor 20 (hereinafter, referred to as an acceleration sensor output value) will be described. When the time integral of the translational acceleration Ax in a time period from time t to time t+Δt can be assumed to be zero, and the translational acceleration Ay in the time period can be assumed to be always zero (alternatively, the time integral of the translational acceleration Ay in the time period is zero), the time integrals of the acceleration sensor output values ax, ay, and az in the time period do not include translational acceleration components and still include gravitational acceleration components and error components. The above characteristics are used to estimate error amounts of the acceleration sensor output values ax, ay, and az. It is noted that even when the time integral of the translational acceleration Ax in the time period from time t to time t+Δt cannot be assumed to be zero, if a change in the vehicle speed ΔV in the time period from time t to time t+Δt can be specified, the error amounts of the acceleration sensor output values ax, ay, and az can be estimated.

As indicated by expression (4), the error amount of the acceleration sensor output value ax is (−gθ cos(roll)cos(pitch)+bx). The error amount of the acceleration sensor output value ay is (gφ cos(roll)cos(pitch)+bx). The error amount of the acceleration sensor output value az is (bz). In the following description, the time period in which the time integral of the translational acceleration Ax from time t to time t+Δt can be assumed to be zero and the translational acceleration Ay from time t to time t+Δt can be assumed to be always zero is referred to as a target time period.

The vehicle 10 frequently travels on a horizontal road surface. When a roll angle and a pitch angle of the vehicle 10 are sufficiently small, it can be assumed that cos(roll)=1, and cos(pitch)=1. Although the roll angle and the pitch angle of the vehicle 10, which is traveling, change due to the shape of the road surface and expansion and contraction of the suspension, the roll angle and the pitch angle of the vehicle 10, which is traveling, are often sufficiently small. Hence, the mode (most frequent value) of the acceleration sensor output value ax in the target time period can be assumed to be (−gθ cos(roll)cos(pitch)+bx). The mode (most frequent value) of the acceleration sensor output value ay in the target time period can be assumed to be (gφ cos(roll)cos(pitch)+by). The mode of the acceleration sensor output value az in the target time period can be assumed to be (g-cos(roll)cos(pitch)+bx). Hence, the mode of ax in the target time period can be assumed to be the error amount of ax. The mode of ay in the target time period can be assumed to be the error amount of ay. A value obtained by subtracting the gravitational acceleration g from the mode of az in the target time period can be assumed to be the error amount of az.

Instead of the method of estimating error amounts using modes of the acceleration sensor output values ax, ay, and az in the target time period, for example, error amounts can also be estimated by using medians of the acceleration sensor output values ax, ay, and az in the target time period, using a values of the acceleration sensor output values ax, ay, and az in the target time period without including any time when the vehicle is stopped, or using average values of the acceleration sensor output values ax, ay, and az in the target time period.

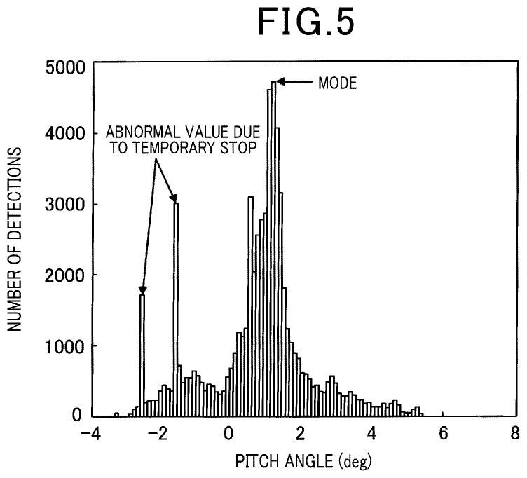

FIG. 5 illustrates an example of a histogram of the pitch angle of the vehicle 10. An error amount of an acceleration sensor output value can be estimated by using the mode of the roll angle and the mode of the pitch angle of the vehicle 10. The vehicle 10 frequently travels on a horizontal road surface. Hence, when no offset error and no mounting angle error have occurred in the acceleration sensor 20, the mode of the roll angle and the mode of the pitch angle of the vehicle 10 become zero. Therefore, the correction amount by which the acceleration sensor output value is corrected so that the mode of the roll angle and the mode of the pitch angle become zero can be estimated to be the error amount of the acceleration sensor output value. In FIG. 5, the mode of the pitch angle of the vehicle 10 is 1.1 degrees. The pitch angle and the roll angle of the vehicle 10 follow normal distributions. Although peaks at which the number of detections is relatively large appear in the vicinity of −2.0 degrees, the peaks are preferably removed when a mode is determined because it can be considered that the peaks are abnormal values caused due to temporary stops of the vehicle 10 on an inclined road surface.

### <Estimation Method of Mounting Angle Error of Acceleration Sensor>

Next, an estimation method of the mounting angle errors φ, θ, and ψ of the acceleration sensor 20 will be described. If the mounting angle errors φ, θ, and ψ of the acceleration sensor 20 can be estimated, it is possible to separate error amounts contained in the acceleration sensor output values ax, ay, and az into those due to an offset error and a mounting angle error.

When the change in the vehicle speed during a time period Δt while the vehicle 10 accelerates/decelerates in a straight line is ΔV, the mounting angle error θ around the Y-axis and the mounting angle error ψ around the Z-axis can be estimated by using the acceleration sensor output values ax, ay, and az acquired while the vehicle 10 accelerates/decelerates in a straight line and the acceleration sensor output values gx, gy, and gz acquired while the vehicle 10 is stopped. The mounting angle error θ around the Y-axis can be expressed by the following expression (9). The mounting angle error ψ around the Z-axis can be expressed by the following expression (10).

$$[ Math . 9 ]$$

$$θ = arctan ( {\int }_{t}^{t + Δ t} ( {a}_{z} - {g}_{z} ) dt / {\int }_{t}^{t + Δ t} ( {a}_{x} - {g}_{x} ) dt ) \qquad ( 9 )$$

$$[ Math . 10 ]$$

$$ψ = arctan ( {\int }_{t}^{t + Δ t} ( {a}_{y} - {g}_{y} ) dt / {\int }_{t}^{t + Δ t} ( {a}_{x} - {g}_{x} ) dt ) \qquad ( 10 )$$

For example, if Δt=5 seconds and ΔV=10 m/s, from the following expression (11) and the following expression (12), θ=0.5 degrees can be estimated. It is noted that the change in the vehicle speed ΔV can be derived using a vehicle speed V acquired from the vehicle speed sensor 40.

$$[ Math . 11 ]$$

$${\int }_{t}^{t + Δ t} ( {a}_{x} - {g}_{x} ) = 1000 mg \qquad ( 11 )$$

$$[ Math . 12 ]$$

$${\int }_{t}^{t + Δ t} ( {a}_{z} - {g}_{z} ) = 8.5 mg \qquad ( 12 )$$

Herein, mg denotes 1/1000 of the gravitational acceleration.

In addition, the mounting angle errors φ around the X-axis can be estimated by using the acceleration sensor output values ay and az acquired while the vehicle 10 travels in a curve and the acceleration sensor output values gy and gz acquired while the vehicle 10 is stopped. The mounting angle errors φ around the X-axis can be expressed by the following expression (13).

$$[ Math . 13 ]$$

$$∅ = arctan ( {\int }_{t}^{t + Δ t} ( {a}_{z} - {g}_{z} - Ax θ ) dt / {\int }_{t}^{t + Δ t} ( {a}_{y} - {g}_{y} ) dt ) \qquad ( 13 )$$

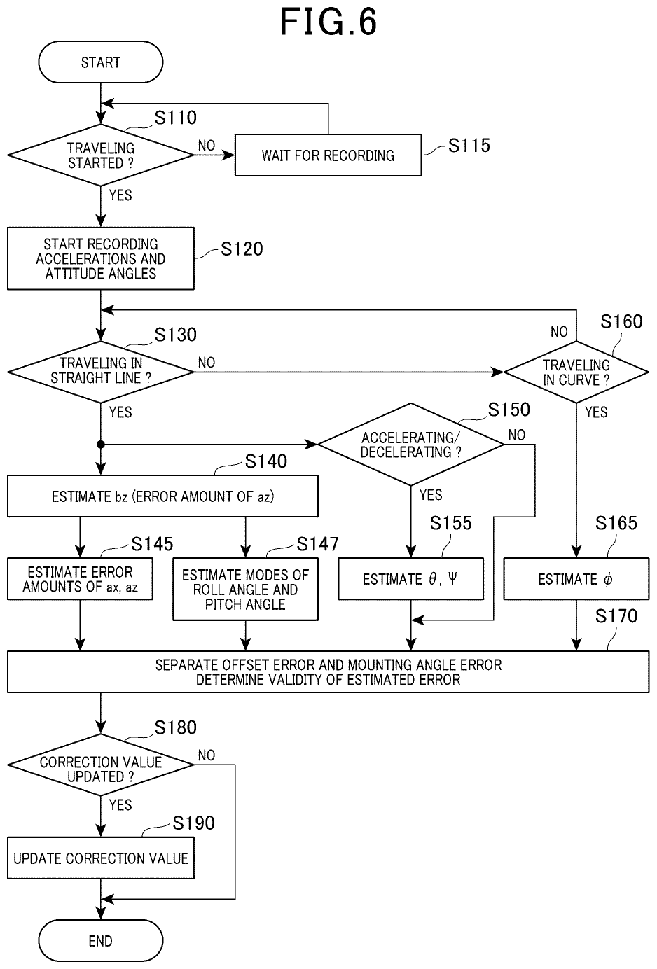

An error estimation process estimating an error of the acceleration sensor 20 illustrated in FIG. 6 is repeatedly performed, after the vehicle 10 is activated, at predetermined intervals by the acceleration error estimation unit 150. In step S110, the acceleration error estimation unit 150 determines whether the vehicle 10 has started traveling. For example, when a vehicle speed acquired from the vehicle speed sensor 40 is not zero, the acceleration error estimation unit 150 determines that the vehicle 10 has started traveling. When determining in step S110 that the vehicle 10 has not started traveling (S110:NO), in step S115, the acceleration error estimation unit 150 waits for a predetermined time period to record accelerations and attitude angles of the vehicle 10, and thereafter returns to the process of step S110.

When determining in step S110 that the vehicle 10 has started traveling (S110:YES), in step S120, the acceleration error estimation unit 150 starts recording accelerations and attitude angles of the vehicle 10. The acceleration error estimation unit 150 writes and stores the accelerations acquired from the acceleration sensor 20 and the attitude angles of the vehicle 10 acquired from the vehicle attitude estimation unit 130 into the memory 102.

In step S130, the acceleration error estimation unit 150 determines whether the vehicle 10 is traveling in a straight line. In the present embodiment, when an angular velocity ωz around the Z-axis acquired from the angular velocity sensor 30 is less than a predetermined threshold value on, the acceleration error estimation unit 150 determines that the vehicle 10 is traveling in a straight line.

When determining in step S130 that the vehicle 10 is traveling in a straight line (S130:YES), in step S140, the acceleration error estimation unit 150 estimates an offset error bz of the acceleration sensor 20 in the Z-axis direction in a target time period in which the time integral of the translational acceleration Ax of the vehicle 10 in the X-axis direction from time t to time t+Δt is zero, and the angular velocity ωz of the vehicle 10 around the Z-axis is less than the threshold value on. When the time integral of the translational acceleration Ax of the vehicle 10 in the X-axis direction is zero, the vehicle speed at time t and the vehicle speed at time t+Δt are the same. Vehicle speeds can be detected by the vehicle speed sensor 40. Angular velocities oz around the Z-axis can be detected by the angular velocity sensor 30. Hence, the acceleration error estimation unit 150 can determine the target time period using the vehicle speed detected by the vehicle speed sensor 40 and the angular velocity detected by the angular velocity sensor 30. The acceleration error estimation unit 150 estimates that a value obtained by subtracting the gravitational acceleration from the mode of the output value az of the acceleration sensor 20 in the Z-axis direction in the target time period is the offset error bz. The acceleration error estimation unit 150 writes and stores the estimated offset error bz (error amount of az) into the memory 102.

After performing the process of step S140, in step S145, the acceleration error estimation unit 150 estimates an error amount of the output value ax of the acceleration sensor 20 in the X direction and an error amount of the output value ay of the acceleration sensor 20 in the Y direction. In the present embodiment, the acceleration error estimation unit 150 estimates that the mode of the output value ax of the acceleration sensor 20 in the X direction in the target time period is the error amount of ax, and estimates that the mode of the output value ay of the acceleration sensor 20 in the Y direction in the target time period is the error amount of ay. The acceleration error estimation unit 150 writes and stores the estimated error amount of ax and the estimated error amount of ay into the memory 102. In step S147, the acceleration error estimation unit 150 estimates modes of the roll angle and the pitch angle of the vehicle 10 in the target time period, based on the attitude angles of the vehicle 10 in the target time period estimated by the vehicle attitude estimation unit 130. The acceleration error estimation unit 150 writes and stores the estimated modes of the roll angle and the pitch angle into the memory 102. Thereafter, the acceleration error estimation unit 150 proceeds to the process of step S170. It is noted that the process of step S147 may not be performed.

When determining in step S130 that the vehicle 10 is traveling in a straight line (S130:YES), further in step S150, the acceleration error estimation unit 150 determines whether the vehicle 10 is accelerating/decelerating. In the present embodiment, when the absolute value of the translational acceleration Ax in the X-axis direction estimated by the vehicle trajectory estimation unit 140 exceeds a predetermined threshold value Ah, the acceleration error estimation unit 150 determines that the vehicle 10 is accelerating/decelerating. When the absolute value of the translational acceleration Ax in the X-axis direction is the predetermined threshold value Ah or less, the acceleration error estimation unit 150 determines that the vehicle 10 is not accelerating/decelerating. When determining in step S150 that the vehicle 10 is accelerating/decelerating (S150:YES), in step S155, the acceleration error estimation unit 150 estimates the mounting angle error θ around the Y-axis and the mounting angle error ψ around the Z-axis. The acceleration error estimation unit 150 writes and stores the estimated mounting angle error θ around the Y-axis and the estimated mounting angle error ψ around the Z-axis into the memory 102. When determining in step S150 that the vehicle 10 is not accelerating/decelerating (S150:NO), the acceleration error estimation unit 150 skips the process of step S155 and proceeds to the process of step S170.

When determining in step S130 that the vehicle 10 is not traveling in a straight line (S130:NO), in step S160, the acceleration error estimation unit 150 determines whether the vehicle 10 is traveling in a curve. In the present embodiment, when the absolute value of a centripetal acceleration (radial acceleration in circular motion) oV of the vehicle 10 around the Z-axis exceeds a predetermined threshold value Ah, the acceleration error estimation unit 150 determines that the vehicle 10 is traveling in a curve. When the absolute value of the centripetal acceleration around the Z-axis is the predetermined threshold value Ah or less, the acceleration error estimation unit 150 determines that the vehicle 10 is not traveling in a curve. When determining in step S160 that the vehicle 10 is traveling in a curve, in step S165, the acceleration error estimation unit 150 estimates the mounting angle errors φ around the X-axis. The acceleration error estimation unit 150 writes and stores the estimated mounting angle errors φ around the X-axis into the memory 102. Thereafter, the acceleration error estimation unit 150 proceeds to the process of step S170. When determining in step S160 that the vehicle 10 is not traveling in a curve (S160:NO), the acceleration error estimation unit 150 returns to the process of step S130.

In step S170, of the error amounts of the acceleration sensor output values ax, ay, and az stored in the memory 102, if the error amount due to an offset error and the error amount due to a mounting angle error can be separated from each other, the acceleration error estimation unit 150 separates the error amount due to an offset error and the error amount due to a mounting angle error from each other. In addition, in step S170, the acceleration error estimation unit 150 determines validity of the estimated error amount. In the present embodiment, when the absolute value of a difference between a current estimated value and a previous estimated value is less than a predetermined threshold value, the acceleration error estimation unit 150 determines that the estimated error amount is valid. When the absolute value of the difference between the current estimated value and the previous estimated value is the predetermined threshold value or more, the acceleration error estimation unit 150 determines that the estimated error amount is not valid.

In step S180, the acceleration error estimation unit 150 determines whether to update a correction value for correcting an error of the acceleration sensor 20. In the present embodiment, when the estimated error amount is valid, the acceleration error estimation unit 150 determines to update the correction value. When the estimated error amount is not valid, the acceleration error estimation unit 150 determines not to update the correction value.

When determining in step S180 to update the correction value (S180:YES), in step S190, the acceleration error estimation unit 150 updates the correction value. The acceleration error estimation unit 150 calculates the correction value based on the estimated error amount to eliminate the error of the acceleration sensor 20, and transmits the calculated correction value to the acceleration correction unit 110. When determining in step S180 not to update the correction value (S180:NO), the acceleration error estimation unit 150 skips the process of step S190. Thereafter, the acceleration error estimation unit 150 terminates the error estimation process.

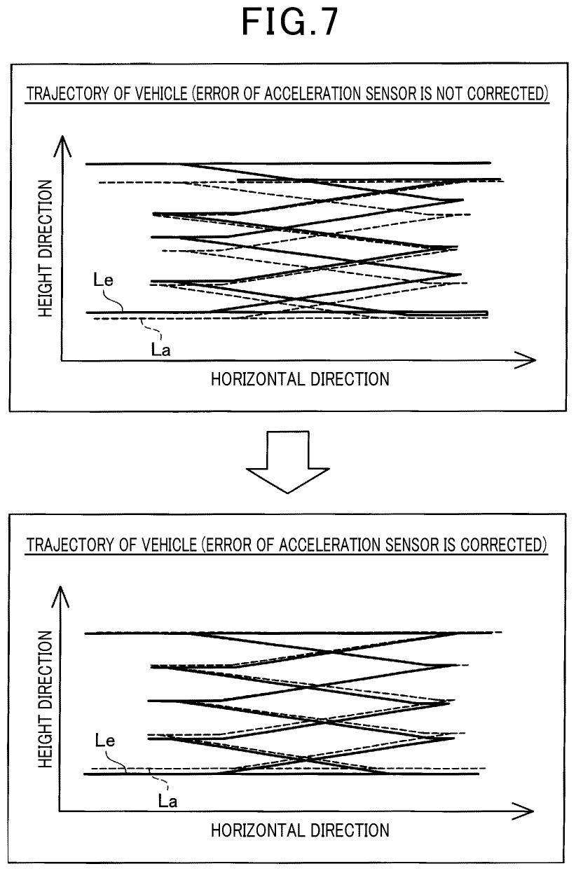

FIG. 7 illustrates a trajectory of the vehicle 10 traveling in a multi-story parking garage. The trajectory of the vehicle 10 viewed in parallel to the horizontal plane is illustrated. In FIG. 7, an estimated trajectory Le, which is a trajectory estimated by the vehicle trajectory estimation unit 140, is represented by solid lines, and an actual trajectory La, which is an actual trajectory, is represented by dashed lines. When an error of the acceleration sensor 20 is not corrected, the difference between the actual trajectory La and the estimated trajectory Le is significant. In contrast, correcting the error of the acceleration sensor 20 based on the error amount estimated by the error estimation process described above can decrease the difference between the actual trajectory La and the estimated trajectory Le.

According to the information processing device 100 of the present embodiment described above, error amounts of the acceleration sensor 20 in the X, Y, and Z-axis directions can be estimated with high accuracy by using output values of the acceleration sensor 20 in the X, Y, and Z-axis directions acquired when the vehicle 10 is traveling. Hence, attitude angles of the vehicle 10 and a trajectory of the vehicle 10 can be estimated with high accuracy by using accelerations of the vehicle 10 detected by the acceleration sensor 20.

In addition, according to the information processing device 100 of the present embodiment, even when the vehicle 10 is not traveling on a flat road surface, an error of the acceleration sensor 20 can be estimated. Furthermore, according to the information processing device 100 of the present embodiment, an error of the acceleration sensor 20 can be estimated without using another means such as a GNSS (Global Navigation Satellite System) or a camera. Furthermore, according to the information processing device 100 of the present embodiment, no distinction between an error amount due to an offset error and an error amount due to a mounting angle error does not affect the correction of an error of the acceleration sensor 20. Furthermore, according to the information processing device 100 of the present embodiment, even if a mounting angle error of the acceleration sensors 20 has occurred, since an error of the acceleration sensor 20 due to the mounting angle error can be corrected, the acceleration sensors 20 can be easily mounted to vehicle body 11.

In addition, according to the information processing device 100 of the present embodiment, since an offset error and a mounting angle error can be estimated, they can be distinguished from each other. Hence, for example, when the mounting angle error is significant, a user or the like can be notified to correct the mounting angle of the acceleration sensors 20 during maintenance.

In addition, according to the information processing device 100 of the present embodiment, error amounts of the acceleration sensor 20 in the X, Y, and Z-axis directions are estimated by using modes of output values of the acceleration sensor 20 in the X, Y, and Z axis-directions. Hence, error amounts of the acceleration sensor 20 in the X, Y, and Z-axis directions can be estimated by simple processing.

### B. Second Embodiment

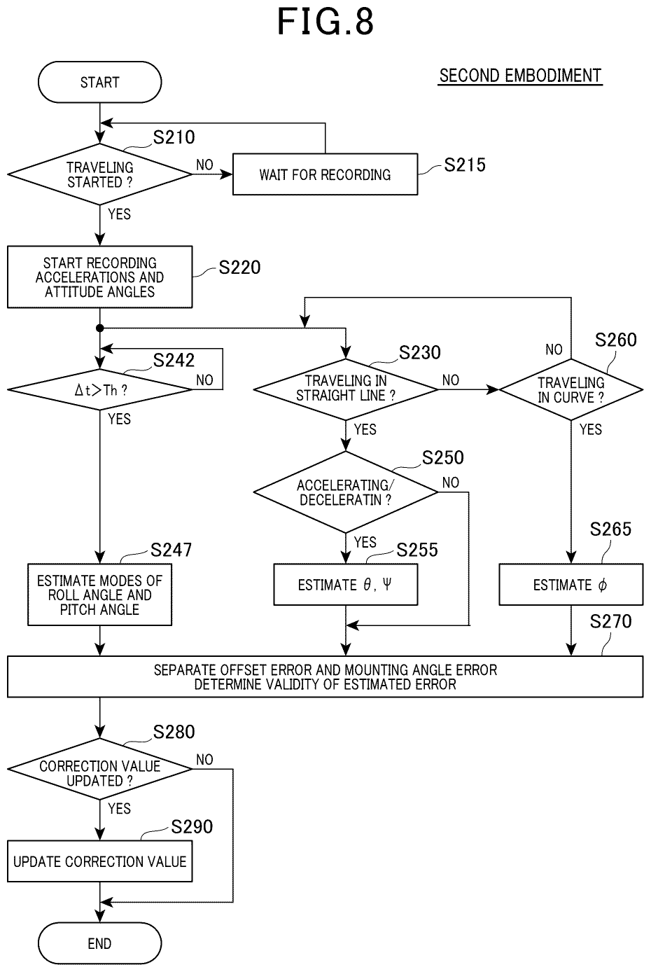

As illustrated in FIG. 8, according to the information processing device 100 of the second embodiment, contents of the error estimation process performed by the acceleration error estimation unit 150 differ from those of the first embodiment. Other configurations are similar to those of the first embodiment unless otherwise specified.

When the error estimation process illustrated in FIG. 8 is started, in step S210, the acceleration error estimation unit 150 determines whether the vehicle 10 has started traveling. When determining in step S210 that the vehicle 10 has not started traveling (S210:NO), in step S215, the acceleration error estimation unit 150 waits for a predetermined time period to record accelerations and attitude angles of the vehicle 10, and thereafter returns to the process of step S210. When determining in step S210 that the vehicle 10 has started traveling (S210:YES), in step S220, the acceleration error estimation unit 150 starts recording accelerations and attitude angles of the vehicle 10 in the memory 102.

After performing the process of step S220, in step S242, the acceleration error estimation unit 150 determines whether a predetermined time period Th has elapsed from the start of recording accelerations and attitude angles of the vehicle 10. The time period Th is preferably, for example, 10 to 20 minutes. Until it is determined in step S242 that the predetermined time period Th has elapsed, the acceleration error estimation unit 150 repeats the process of step S242. When determining in step S242 that the predetermined time period Th has elapsed (S242:YES), in step S247, the acceleration error estimation unit 150 estimates modes of the roll angle and the pitch angle of the vehicle 10 in the target time period, based on the attitude angles of the vehicle 10 in the target time period estimated by the vehicle attitude estimation unit 130. The acceleration error estimation unit 150 writes and stores the estimated modes of the roll angle and the pitch angle into the memory 102. Thereafter, the acceleration error estimation unit 150 proceeds to the process of step S270.

After performing the process of step S220, furthermore, in step S230, the acceleration error estimation unit 150 determines whether the vehicle 10 is traveling in a straight line. When determining in step S230 that the vehicle 10 is traveling in a straight line (S230:YES), in step S250, the acceleration error estimation unit 150 determines whether the vehicle 10 is accelerating/decelerating. When determining in step S250 thatthe vehicle 10 is accelerating/decelerating (S250:YES), in step S255, the acceleration error estimation unit 150 estimates the mounting angle error θ around the Y-axis and the mounting angle error ψ around the Z-axis. The acceleration error estimation unit 150 writes and stores the estimated mounting angle error θ around the Y-axis and the estimated mounting angle error ψ around the Z-axis into the memory 102. When determining in step S250 that the vehicle 10 is not accelerating/decelerating (S250:NO), the acceleration error estimation unit 150 skips the process of step S255 and proceeds to the process of step S270.

When determining in step S230 that the vehicle 10 is not traveling in a straight line (S230:NO), in step S260, the acceleration error estimation unit 150 determines whether the vehicle 10 is traveling in a curve. When determining in step S260 that the vehicle 10 is traveling in a curve, in step S265, the acceleration error estimation unit 150 estimates the mounting angle errors φ around the X-axis. The acceleration error estimation unit 150 writes and stores the estimated mounting angle errors φ around the X-axis into the memory 102. Thereafter, the acceleration error estimation unit 150 proceeds to the process of step S270. When determining that the vehicle 10 is not traveling in a curve (S260:NO), the acceleration error estimation unit 150 returns to the process of step S230.

In step S270, the acceleration error estimation unit 150 estimates error amounts of the acceleration sensor output values ax, ay, and az using the mode of the roll angle and the mode of the pitch angle of the vehicle 10 stored in the memory 102. Of the error amounts of the acceleration sensor output values ax, ay, and az, if the error amount due to an offset error and the error amount due to a mounting angle error can be separated from each other, the acceleration error estimation unit 150 separates the error amount due to an offset error and the error amount due to a mounting angle error from each other. As described above, the acceleration error estimation unit 150 can estimate the error amounts of the acceleration sensor output values ax, ay, and az by using the mode of the roll angle and the mode of the pitch angle of the vehicle 10. In addition, in step S270, the acceleration error estimation unit 150 determines validity of the estimated error amount. In step S280, the acceleration error estimation unit 150 determines whether to update a correction value for correcting an error of the acceleration sensor 20. When determining in step S280 to update the correction value (S280:YES), in step S290, the acceleration error estimation unit 150 calculates the correction value based on the estimated error amount, and transmits the calculated correction value to the acceleration correction unit 110. When determining in step S280 not to update the correction value (S280:NO), the acceleration error estimation unit 150 skips the process of step S290. Thereafter, the acceleration error estimation unit 150 terminates the error estimation process.

Also according to the information processing device 100 of the present embodiment described above, error amounts of the acceleration sensor 20 in the X, Y, and Z-axis directions can be estimated with high accuracy by using output values of the acceleration sensor 20 in the X, Y, and Z-axis directions acquired when the vehicle 10 is traveling.

### C. Other Embodiments

(C1) The information processing device 100 of each of the embodiments described above is installed in the vehicle 10. In contrast, in other embodiments, the information processing device 100 may be located outside the vehicle 10. In this case, the information processing device 100 may acquire output values of the various sensors 20, 30, and 40 mounted to the vehicle 10 via radio communication.

(C2) The information processing device 100 of each of the embodiments described above estimates an error of the acceleration sensor 20, corrects the error of the acceleration sensor 20 using the estimation result, and uses the corrected acceleration sensor output value for estimating a trajectory of the vehicle 10. For example, the vehicle 10 may include various actuators such as an engine control actuator that opens and closes a throttle valve, a brake actuator that adjusts braking force, and a steering actuator that controls steering operations. The information processing device 100 may be electrically connected to the above-described actuators and, for example, transmit control signals to them based on the estimated trajectory. In this manner, the information processing device 100 can perform vehicle control, such as driving assistance, based on the estimated trajectory. In other embodiments, the information processing device 100 may use the corrected acceleration sensor output value for vehicle control such as automatic parking.

The present disclosure is not limited to the above-described embodiments and can be implemented with various configurations within a scope that does not deviate from the gist of the present disclosure. For example, technical features in the embodiments can be appropriately replaced or combined with each other in order to solve all or part of the objects described above or to achieve all or part of the effects described above. Some of the technical features can be appropriately deleted if they are not described as essentials herein.

The following supplementary notes are provided regarding the techniques disclosed herein.

### <Supplementary Notes>

### Aspect 1

An information processing device includes:
an acquisition unit that acquires an output value of an acceleration sensor mounted to a vehicle and an output value of a vehicle speed sensor mounted to the vehicle; and
an estimation unit that estimates an error amount of the output value of the acceleration sensor, based on the output value of the acceleration sensor in a time period in which a time integral of a translational acceleration of the vehicle in a lateral axis direction is zero and on a change in a vehicle speed of the vehicle in the time period derived from the output value of the vehicle speed sensor.

### Aspect 2

The information processing device according to Aspect 1, in which the estimation unit may estimate an error amount of the output value of the acceleration sensor including an error amount due to a mounting angle error of the acceleration sensor to the vehicle and an error amount due to an offset error of the acceleration sensor, based on the output value of the acceleration sensor in the time period and the change in the vehicle speed in the time period.

### Aspect 3

The information processing device according to Aspect 1 or Aspect 2, in which the estimation unit may estimate the error amount based on a mode of the output value of the acceleration sensor.

### Aspect 4

An error estimation method for an acceleration sensor includes:
acquiring an output value of an acceleration sensor mounted to a vehicle and an output value of a vehicle speed sensor mounted to the vehicle; and
estimating an error amount of the output value of the acceleration sensor, based on the output value of the acceleration sensor in a time period in which a time integral of a translational acceleration of the vehicle in a lateral axis direction is zero and on a change in a vehicle speed of the vehicle in the time period derived from the output value of the vehicle speed sensor.

In the present disclosure and in the claims, the term “processor” refers to one or more hardware processors configured to execute processing defined by computer program code included in a computer program, by successively loading the computer program code (that is, one or more instructions of the computer program). In other words, the “processor” is a hardware device that executes one or more programmed processes. Accordingly, the computer program code may be regarded as software capable of defining the processing performed by the processor, depending on its content. The “processor” may be a general-purpose or a dedicated processor, such as a CPU, microprocessor, GPU, or DFP (Data Flow Processor), but is not limited thereto.

The term “memory” refers to one or more non-transitory tangible storage medium, which are hardware memories configured to store computer program code and/or data in a manner accessible by a processor. The “memory” may be implemented using memory technologies and architectures such as SRAM, SDRAM, non-volatile memory, flash memory, or other types of memory.

In the present disclosure and in the claims, the term “circuit” refers to one or more hardware logic circuits configured to execute specific processing based on a predefined circuit design. In other words, the term “circuit” in the present disclosure and claims does not refer to a device in which processing is defined by software such as the above-described computer program code. Instead, it refers to a hardware device that executes specific processing based on its circuit configuration. For example, the “circuit” may include custom integrated circuits such as ASICs (Application Specific Integrated Circuits) or FPGAs (Field Programmable Gate Arrays) designed using a hardware description language (HDL). Accordingly, the term “circuit” as used in the present disclosure and claims includes all hardware circuits except for the above-described processors that execute processing by loading computer program code.

What is claimed is:

1. An information processing device, comprising:
an acquisition unit that acquires an output value of an acceleration sensor mounted to a vehicle and an output value of a vehicle speed sensor mounted to the vehicle; and
an estimation unit that estimates an error amount of the output value of the acceleration sensor based on the output value of the acceleration sensor in a time period in which a time integral of a translational acceleration of the vehicle in a lateral axis direction is zero and on a change in a vehicle speed of the vehicle in the time period derived from the output value of the vehicle speed sensor.

2. The information processing device according to claim 1, wherein
the estimation unit estimates an error amount of the output value of the acceleration sensor including an error amount due to a mounting angle error of the acceleration sensor to the vehicle and an error amount due to an offset error of the acceleration sensor, based on the output value of the acceleration sensor in the time period and the change in the vehicle speed in the time period.

3. The information processing device according to claim 1, wherein
the estimation unit estimates the error amount based on a mode of the output value of the acceleration sensor.

4. An error estimation method for an acceleration sensor, the method comprising:
acquiring an output value of an acceleration sensor mounted to a vehicle and an output value of a vehicle speed sensor mounted to the vehicle; and
estimating an error amount of the output value of the acceleration sensor, based on the output value of the acceleration sensor in a time period in which a time integral of a translational acceleration of the vehicle in a lateral axis direction is zero and on a change in a vehicle speed of the vehicle in the time period derived from the output value of the vehicle speed sensor.

5. An information processing device, comprising:
(i) a circuit, (ii) a processor with a memory storing computer program code executable by the processor, or (iii) both the circuit and the processor, at least one of the circuit and the processor configured to be communicably connected with an acceleration sensor and a vehicle speed sensor, and to cause the information processing device to:
acquires an output value of the acceleration sensor mounted to a vehicle and an output value of the vehicle speed sensor mounted to the vehicle; and
estimates an error amount of the output value of the acceleration sensor based on the output value of the acceleration sensor in a time period in which a time integral of a translational acceleration of the vehicle in a lateral axis direction is zero and on a change in a vehicle speed of the vehicle in the time period derived from the output value of the vehicle speed sensor.
